(19) United States
(12) Patent Application Publication
(10) Pub. No.: US 2008/0094481 A1
(43) Pub. Date: Apr. 24, 2008

(54) Intelligent Multiple Exposure

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/551,128

(22) Filed: Oct. 19, 2006

(51) Int. Cl. H04N 5/228

(52) U.S. Cl. 348/222.1

(57) ABSTRACT

In one embodiment, an apparatus creates a multiple exposure image from two or more frames of pixels. The apparatus includes a first memory to store pixels of a first frame and a comparing unit. The comparing unit, for pixels of a second frame, compares at least one parameter with a first threshold to determine if a first condition is true, selects pixels for which the first condition is true, and stores the selected pixels in the first memory. The selected pixels are stored subsequent to the storing of the first frame by replacing corresponding pixels of the first frame with the selected pixels. In one embodiment, the comparing unit compares pixels of a third frame and stores the selected pixels of the third frame in the memory subsequent to the storing of the selected pixels of the second frame.

### FIELD OF INVENTION

The field of invention relates to methods and apparatus for creating a multiple exposure image from two or more frames of image data.

### BACKGROUND

A photograph made by exposing a single frame of film two times to two different images is referred to as a “double exposure.” The resulting photograph shows the second image superimposed over the first. When the film or image sensor is exposed multiple times to multiple different images, the technique is referred to as “multiple exposure.”

One use of the multiple exposure technique is to create a multiple-image photograph of a moving subject. Different effects may be obtained by varying the time between the exposures. For instance, sometimes in scientific photographs such as those illustrating the path of a falling object, each exposure is separated by a relatively long period of time so that relatively few images of the object are captured at distinct points along its trajectory. In other cases, such as in photographs taken for aesthetic effect, each exposure is separated by a relatively short period of time so that a very large number of images of the object are captured. For example, in a photograph showing the headlights of a moving car at night, multiple closely spaced exposures depict the headlights in the resulting photograph as streaks of light.

One problem that can occur when creating multiple-exposure images is that if the film is exposed to too much light, the picture will turn out overexposed. For example, if the first and second images of the person are captured in front of the same background, the objects in the background may appear “washed out” as a result of being overexposed. Accordingly, the images from which a multiple-exposure image is created may need to be taken under carefully controlled lighting conditions. Photographers, especially those who are inexperienced, may not exercise adequate control over lighting conditions and, as a result, will take resulting in unsatisfactory multiple-exposure images. Additionally, it may not be possible to adequately control the lighting conditions. For example, in outdoor photography the weather and nearby sources of ambient light, such as city lights at night, are beyond the control of even the experienced photographer.

Another related problem that occurs when first and second images of a person are captured in front of the same background is that images of the person are less distinct than they would appear in a single exposure image as they are blended with the background. See FIG. 8, which is described below.

A further problem that may be encountered when creating a double exposure image arises when the photographer does not desire to superimpose the entire second image over the first image. For example, the photographer may wish to superimpose only a single object of interest in the foreground but not the entire background of a second image over the first image.

Accordingly, solutions to the problems of undesired lighting and images would be desirable.

Digital cameras are rapidly replacing traditional film cameras. While traditionally employed with film, the multiple exposure technique can be used with an image sensor that is capable of producing a single frame when exposed two or more times.

One problem encountered when a photographer desires to create a multiple exposure image with a digital camera is that the camera may provide only limited functionality. For instance, digital cameras with the multiple exposure capability often limit the number of exposures to a small number of exposures, such as 2-10 exposures. In some situations, however, a photographer desires to have the image sensor exposed a large number of times to a large number of different images. For example, the photographer may wish to take a 600 exposure image of stars on a dark night over a 10 hour period. Presumably, the reason that digital cameras lack a multiple exposure function capable of capturing a large number of images is to minimize cost of the device.

Another problem encountered when a photographer desires to create a multiple exposure image is that the camera may simply lack a multiple exposure function. This is especially true in the case where an image sensor is integrated into another device, such as a mobile telephone. The reason that camera-equipped mobile telephones lack the multiple exposure function is to minimize cost of the device. It is often the case, however, that the photographer encounters a “photo opportunity” in unexpected situations. As the photographer carries his camera-equipped mobile telephone most of the time, it is often the case that the only manner for taking advantage of photo opportunity is to take the shot with his camera-equipped mobile telephone.

Accordingly, a low-cost multiple exposure function capable of capturing a large number of exposures for use in digital cameras would be desirable. In addition, a low-cost multiple exposure function for use in camera-equipped mobile devices would be desirable.

It is possible to create the multiple exposure effect using special-purpose software for manipulating digital photographs. Disadvantages of using photograph editing software include increased storage requirements in the camera as multiple image files are needed to create one photo. Increasing memory requirements increases cost and power consumption. Moreover, special-purpose software requires the photographer to purchase the software and a personal computer to run the software. This increases the cost to the photographer. Further, the photographer must learn how to use the software to combine multiple images. Further, the photographer only sees the results of an attempt to create a multiple exposure image a long time after the images were captured.

Thus, there is a need for am inexpensive apparatus that is simple to use that creates a multiple exposure effect in a digital camera contemporaneous with image capture.

Accordingly, there is a need for methods and apparatus for creating a multiple exposure image from two or more frames of image data.

### SUMMARY

In one embodiment, a method is disclosed for creating a multiple exposure image from two or more frames of pixels. Each pixel is defined by at least one parameter. The method includes storing pixels of a first frame in a memory. In addition, for pixels of a second frame, at least one parameter for defining pixels is compared with a first threshold to determine if a first condition is true. Further, pixels of the second frame for which the first condition is true are selected. Moreover, selected pixels of the second frame are stored in the memory. The selected pixels are stored subsequent to the storing of the pixels of the first frame. The selected pixels are stored by replacing corresponding pixels of the first frame with the selected pixels.

The first condition, in one embodiment, is that the at least one parameter is greater than the first threshold. In another embodiment, the first condition is that the at least one parameter is less than the first threshold. In addition, in one embodiment the first threshold specifies a brightness parameter. In another embodiment, the first threshold specifies a color difference parameter. In yet another embodiment, the first threshold specifies a color parameter.

In one embodiment, for pixels of a third frame, at least one parameter for defining pixels is compared with the first threshold to determine if the first condition is true. In this embodiment, pixels of the third frame for which the first condition is true are selected. In addition, selected pixels of the third frame are stored in the memory subsequent to the storing the selected pixels of the second frame by replacing corresponding pixels of the first frame with the selected pixels of the third frame.

In another embodiment, an apparatus for creating a multiple exposure image from two or more frames of pixels is disclosed. Each pixel is defined by one or more parameters. The apparatus includes a first memory to store pixels of a first frame and a comparing unit. The comparing unit compares pixels of a second frame. The comparing unit compares at least one parameter with a first threshold to determine if a first condition is true. The comparing unit selects pixels for which the first condition is true and stores the selected pixels in the first memory. The selected pixels are stored subsequent to the storing the first frame by replacing corresponding pixels of the first frame with the selected pixels. In one embodiment, the comparing unit compares pixels of a third frame and stores the selected pixels of the third frame in the memory subsequent to the storing of the selected pixels of the second frame.

In one embodiment, the first condition is that the at least one parameter be greater than the first threshold. In another embodiment, the first condition is that the at least one parameter be less than the first threshold. In addition, in one embodiment, the first threshold specifies a brightness parameter. In another embodiment, the first threshold specifies a color difference parameter. In one embodiment, the apparatus includes a second memory coupled with the comparing unit to store parameters used by the comparing unit.

In yet another embodiment, a system for creating a multiple exposure image from two or more frames of pixels is disclosed. Each pixel is defined by one or more parameters. In one embodiment, the system includes a first memory to store pixels of a first frame and a comparing unit. The comparing unit compares pixels of a second frame. The comparing unit compares at least one parameter with a first threshold to determine if a first condition is true. In addition, the comparing unit compares selects pixels for which the first condition is true, and stores the selected pixels in the first memory. The storing is subsequent to the storing the first frame and is accomplished by replacing corresponding pixels of the first frame with the selected pixels. The first condition is one of the at least one parameter being greater than or less than the first threshold.

In one embodiment, the first memory is of a size sufficient to store not more than one frame. In other embodiments, the system includes an image sensor, a display device, or a host. In addition, in one embodiment, the first threshold specifies a gray scale parameter.

### BRIEF DESCRIPTION OF THE DRAWINGS

FIG. 1a illustrates a perspective view of the front of an exemplary mobile device in an open configuration.

FIG. 1b illustrates a back side view of the mobile device of FIG. 1a in a closed configuration.

FIG. 2 shows a block diagram of the mobile device of FIG. 1a, which includes an exemplary display controller.

FIG. 3 illustrates a block diagram of the display controller of FIG. 2 that can include embodiments of the present invention.

FIG. 4 depicts a flow diagram of an exemplary method in accordance with embodiments of the present invention.

FIG. 5 illustrates a prophetical, first multiple exposure image created from multiple frames separated by relatively short interframe periods in accordance with embodiments of the present invention.

FIG. 6 illustrates a prophetical, second multiple exposure image created from multiple frames separated by relatively long interframe periods in accordance with embodiments of the present invention.

FIG. 7 illustrates multiple frames from which the image the second image of FIG. 6 was created, and the second image.

FIG. 8 depicts a prophetical, image created in which the multiple frames of FIG. 7 are combined in an additive-write operation.

In drawings and description below, the same reference numbers are used in the drawings and the description to refer to the same or like parts, elements, or steps.

### DETAILED DESCRIPTION

In this description, particular structures, processes, operations well known to the person of ordinary skill in the art may not be described in detail in order not to obscure the description. On the other hand, certain structures, processes, operations may be described in some detail even though such details may be well known to the person of ordinary skill in the art, for example, for the benefit of the reader who may not be a person of ordinary skill in the art. In the latter case, one of ordinary skill in the art will recognize that embodiments of the claimed inventions may be practiced without some or all of the specific details that are described.

In this description, references may be made to “one embodiment” or “an embodiment.” These references mean that a particular feature, structure, or characteristic described in connection with the embodiment is included in at least one embodiment of the claimed inventions. Thus, the appearances of the phrase “in one embodiment” or “an embodiment” in various places below are not necessarily all referring to the same embodiment. Furthermore, the particular features, structures, or characteristics may be combined in one or more embodiments.

Methods and apparatus of the claimed inventions can be used in “mobile devices.” A mobile device is a computer or communication system, such as a mobile telephone, personal digital assistant, digital music player, digital camera, or other similar device. Accordingly, as an example, one preferred embodiment of the claimed inventions is described below in the context of a mobile device. It should be appreciated, however, that embodiments of the claimed inventions may be employed in any device capable of processing image data, including but not limited to computer and communication systems and devices generally.

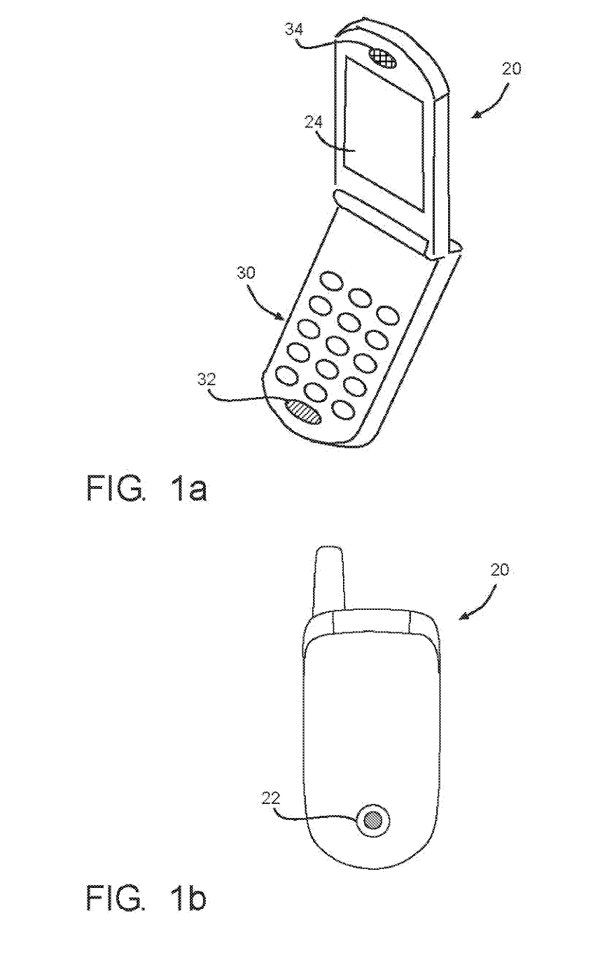

FIG. 1a illustrates a perspective view of the front of an exemplary mobile device in an open configuration. FIG. 1b illustrates a view of the back of the exemplary mobile device in a closed configuration. The numbered features are described below.

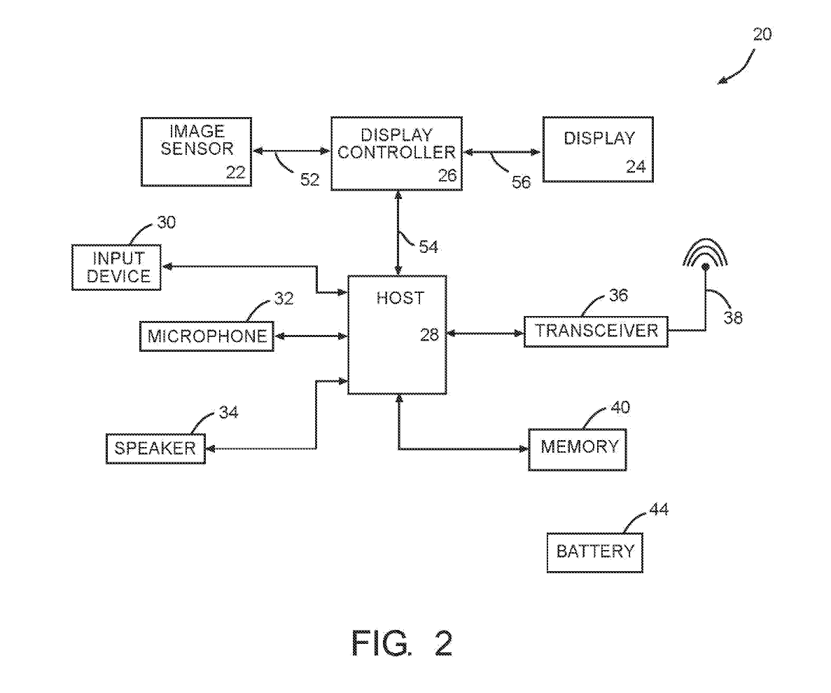

FIG. 2 shows a block diagram of the mobile device 20. The mobile device 20 includes an image sensor 22 for capturing image data. Generally, image sensors have an array of small, light-detecting elements known as “photosites,” each of which converts incident light into an analog voltage. The voltage is subsequently converted into one or more digital values. Exemplary image sensors include charge coupled devices (“CCDs”) and complimentary metal oxide semi-conductor (“CMOS”) sensors. Image sensors are commonly housed in a discrete, dedicated integrated circuit (“IC”).

The mobile device 20 includes a display device 24. The display device 24 is typically an LCD panel but may be any device capable of rendering image data, including CRT, plasma, and OLED display devices. In some embodiments, the display device 24 is a hard copy rendering device, such as a printer.

The image on the screen of a display device is formed from an array of small, discrete picture elements referred to as pixels. The attributes of each pixel, such as its brightness and color, are represented by one or more numbers. The digital values generated by the image sensor 22 are used to create the parameters that define the pixels. The values that define the pixels may be specified in one or more color models (a mathematical model for describing a gamut of colors). A color model known as RGB is generally used when transmitting image data to a display device. Another color model known as YUV is frequently used for processing image data. In the RGB model, a pixel is defined by red, green, and blue parameters. In the YUV model, a pixel is defined by a luma parameter (Y), and two color difference parameters (U and V). Image sensors commonly output image data defined in the RGB or YUV color space.

The two-dimensional matrix or array of pixels that form an image on a display screen is generally referred to as a frame. For instance, the display screen employed in a mobile device sometimes has 320 rows with each row containing 240 pixels, which is used to display a 320×240 frame of pixels. (For convenience of explanation and in accordance with the use of the term in the art, the term “pixel” is used herein to refer at times to the picture elements of a display device, at times to the binary elements of data that are stored and manipulated within a system or apparatus and which define the attributes of such picture elements, and at times to both, the appropriate sense of the term being clear from the context.) Each of the 76,800 pixels in the 320×240 frame of pixels can be uniquely identified by its row and column coordinate position within the matrix. While the term “frame” often refers to an array of pixels that is the same size as the display screen, this term is used in this description and in the claims to refer to frames of any size. In other words, the term frame refers to a matrix of pixels that may be larger, smaller, or the same size as any particular display screen.

The image sensor 22 typically outputs a frame of pixels in “raster” scan order, that is, in rows, proceeding from left to right within each row, and from the top to the bottom row of the matrix. For purposes of the claimed inventions, however, it is not essential that pixel data be output by the image sensor 22 in raster order. What is important is that all of the pixels for a particular frame be output as a single group. For example, consider three frames output from a sensor. It is important that all of the pixels of the first frame be output as a group, all of the pixels of the second frame be output as a group, and all of the pixels of the third frame be output as a group. The pixels within each of the three groups may be in any order. However, the pixels of each frame are preferably output in the same order, and preferably, the pixels of each frame are output in raster order.

When the image sensor 22 is active, frames are output from the image sensor 22 and transmitted to the display controller 26 in a sequential order. The sequence in which frames are transmitted to the display controller 26 typically corresponds with the temporal sequence in which the frames were captured. The sequence of frames may be used to create a video image on display 24.

When the image sensor 22 is active, the frames are output at a “frame rate.” For example, the image sensor 22 may output 24 frames per second (“fps”). With each frame, the image sensor's photosites are exposed to the incident light for a particular duration (“exposure”). In this description, for simplicity of explanation, except where specifically indicated otherwise, the exposure is equal for each frame in a sequence of frames. In addition, each frame is separated in time from a preceding frame by a particular time period (“interframe period”). Again, in this description, for simplicity of explanation, except where specifically indicated otherwise, the length of the interframe period is equal for each frame in a sequence of frames. To further illustrate, consider the example of the sensor outputting 24 fps. Each frame may have an exposure of 0.0167 ( 1/60) seconds and each subsequent frame will be captured after a delay of 0.0250 seconds following the capture of the preceding frame. As another example, each frame may have an exposure of 0.008 ( 1/125) seconds and each subsequent frame will be captured after a delay of 0.0337 seconds following the capture of the preceding frame.

The mobile device 20 includes a display controller 26 that is coupled with the image sensor 22 and display device 24. The display controller 26 processes the image data it receives and transmits image data to the display device 24. The display controller 26 drives the display device 24 according to the timing protocol required by the display and also provides the display device 24 with required control signals. The display controller 26 is further described below.

The display controller 26 is also coupled with a host device 28. The host 28 may be a central processing unit, a digital signal processor, or other processor. The host 28 is coupled with various input/output devices. In the shown embodiment, the host 28 is coupled with an input device 30, a microphone 32, and a speaker 34. The input device 30 may include input keys, a ten-key pad, a keyboard, a pointing device such as a mouse or trackball, or combination of such mechanisms. In addition, the host 28 is coupled with a transceiver 36, which is coupled with an antenna 38, and a memory 40. The memory 40 may be DRAM, SRAM, Flash memory, hard disk, optical disk, floppy disk, or any other type of memory. The memory 40 may be for the exclusive use of the host 28 or may be available for use by other components of the mobile device 20. In general, the host 28 controls various components of the device 20 and is preferably adapted to communicate with or to cause the device 20 to communicate with other computer and communication systems. The mobile device 20 is optionally powered by a battery 44.

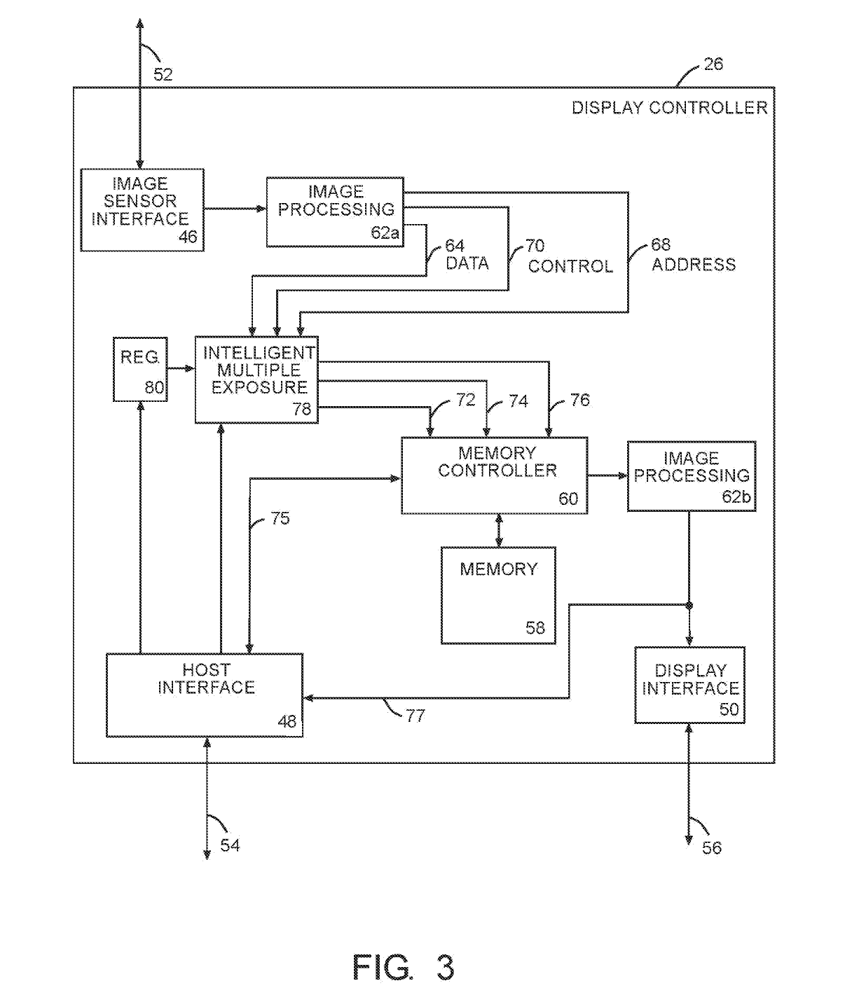

Referring to FIG. 3, a block diagram of one exemplary embodiment of the display controller 26 is shown. The display controller 26 is preferably a discrete IC, disposed remotely from the image sensor 22, the host 28, the display device 24, the memory 40, and other components of the computer or communication system or device of which it is a component. However, it is not critical that the display controller 26 be implemented as a discrete IC. In alternative embodiments, the display controller 26 may be provided within another device or component, such as within an image sensor, processor, memory, or display device.

The display controller 26 includes an image sensor interface 46, a host interface 48, and a display interface 50. The image sensor interface 46 is coupled with the image sensor 22 via a bus 52. The host interface 48 is coupled with the host 28 via a bus 54. And the display interface 50 is coupled with the display device 24 via a bus 56.

The image sensor interface 46 enables the display controller 26 to communicate over the bus 52 using the protocol required by the bus 52. For example, the display controller 26 may program the image sensor 22 via the image sensor interface 46 and bus 52. The bus 52 may be a serial or parallel bus, and may be comprised of two or more busses. In addition, the image sensor interface 46 receives image data from the image sensor 22.

The host interface 48 enables the display controller 26 to communicate with the host 28 over the bus 54 using a protocol required by the bus 54. For example, the host may issue commands or send image data to the display controller 26 via the host interface 48 and bus 54. In addition, the display controller 26 may send image data or command responses to the host 28. The bus 54 may be a serial or parallel bus, and may be comprised of two or more busses.

The display interface 50 receives image data suitable for display from the memory 58, and sends the image data and display commands to the display device 24 via bus 56 in accord with the protocol and timing requirements required by the display device 24. The bus 56 may be a serial or parallel bus.

The display controller 26 includes a memory 58 and a memory controller 60. The memory 58 is embedded in the display controller 26, but in alternative embodiments it may be provided in a separate IC or device. The memory 58 may be a memory dedicated for the purpose of storing image data, or it may be a memory used for storing both image data and other types of data. In one embodiment, the memory 58 is of a size that is sufficient for storing only one frame of image data. In another embodiment, the memory 58 is of a size that is sufficient for storing just one frame of image data along with other non-image data. In this embodiment, the memory is not sufficiently large to store more than one frame. In other embodiments, the memory 58 may be larger or smaller than the two embodiments just described. The memory 58 is of the SRAM type, but the memory 58 may be a DRAM, Flash memory, hard disk, optical disk, floppy disk, or any other type of memory. The memory controller 60 controls access to the memory 58. The memory controller 60 receives read and write access commands, row and column addresses, and data. The memory controller 60 issues responses to the commands it receives, accepts data for storage, and outputs data in response to read requests. The memory controller 60 arbitrates between multiple memory requests and performs other functions related to management of the memory 58.

The display controller 26 includes image processing units 62a and 62b. The image processing units 62a, 62b optionally performs one or more operations on image data, such as converting pixels from one color space to another, sub-sampling YUV data to create, for example, YUV 4:2:0 data from YUV 4:4:4 data, or compressing image data using JPEG or another image compression technique. In addition, the image processing units 62a, 62b may scale image data to create a larger or smaller image. Further, the image processing units 62a, 62b may crop one or more portions of an image. Additionally, the image processing units 62a, 62b may add a border to an image or overlay one image with another. The image processing units 62a, 62b may combine the image data it processes with other image data. The image processing units 62a, 62b may perform operations other than those described, as the described operations are intended to be an illustrative, but not exhaustive description of possible image processing operations. Moreover, particular image processing operations may be performed either before image data is stored in or after it is fetched from the memory 58. For instance, it may be desirable to perform certain operations before storing, such as cropping, down-scaling, and compressing, and some operations after fetching, such as up-scaling, de-compressing, and color space conversion. In the former case, image processing is performed in unit 62a, while in the latter case image processing is performed in unit 62b.

The image processing unit 62a, in addition to performing image processing operations, may specify memory addresses for pixels based on the unique coordinates of each pixel. The image processing unit 62a provides pixel data on a data bus 64, address data on an address bus 68, and one or more control signals on a control bus 70 as shown in FIG. 3. The control signals are used to signal when pixel data and addresses are available for sampling on the respective busses.

The display controller 26 additionally includes an intelligent multiple exposure unit 78 and a register 80. In the shown example, the intelligent multiple exposure unit 78 is coupled with the output of the image processing unit 62a from which it receives image data, and address and control signals via busses 64, 68, and 70, respectively. In addition, the intelligent multiple exposure unit 78 is coupled with the register 80 from which it obtains various process parameters described below. Both the intelligent multiple exposure unit 78 and the register 80 are coupled with the host interface 48. The host 28 issues commands to the intelligent multiple exposure unit 78 and stores process parameters in the register 80 via the host interface 48. Further, the intelligent multiple exposure unit 78 is coupled with the memory controller 60 via data, control, and address buses 72, 74, and 76, respectively.

The intelligent multiple exposure unit 78 may be active or inactive. The default state of the intelligent multiple exposure unit 78 is inactive. In one operation of the mobile device 20 in which the intelligent multiple exposure unit 78 is inactive, an image is captured by the image sensor 22 and image data is transmitted to the display controller 26 via the image sensor interface 46. The image processing unit 62a receives the image data and applies a scaling algorithm, such as down-scaling the image by deleting some pixels and selecting others for storage in the memory 58. The image processing unit 62a transmits image data, and address and control signals to the intelligent multiple exposure unit 78. Even though inactive, the intelligent multiple exposure unit 78 transmits the image data it receives from the image processing unit 62a to the memory control unit 60. After a frame of image data has been captured, processed, and stored, the memory 58 contains one frame of image data. The image processing unit 62b fetches the frame of image data from the memory 58, further processes the image data, such as by applying a color conversion algorithm to the data, and provides the processed image data to the display interface 50 for transmission to the display device 24. Alternatively, the image processing unit 62a provides the processed image data to the host 28 for storage in the memory 40 or transmission to another computer or communication system.

On the other hand, intelligent multiple exposure unit 78 may be active. In another operation mobile device 20, a user wishes to create a multiple exposure image from two or more frames of image data according to the claimed inventions, and the user provides an appropriate command or commands to activate the intelligent multiple exposure unit 78.

The command or commands to activate the intelligent multiple exposure unit 78 are provided to the host using, for example, the input device 30 and a suitable user interface. The user may specify one or more process parameters to be used in creating the image or the process parameters may be predetermined. The details of the user interface and the manner in which commands are entered are not important to the claimed inventions. One of ordinary skill in the art will appreciate several ways in which such commands may be entered.

User commands and process parameters are received by the host 28. Upon receiving such commands, the host 28 activates the intelligent multiple exposure unit 78 and may store one or more process parameters in the register 80 via the host interface 48. Upon activation, a multiple exposure image is created from two or more frames of pixels. A first image is captured by the image sensor 22 and a first frame of image data is transmitted to the display controller 26. The first frame is processed and the parameter values for pixels of the first frame are stored in the memory 58.

Each pixel is defined by at least one parameter value. For example, each pixel may be defined by a gray scale value. As another example, in the case of YUV or RGB data, each pixel is defined by three parameters. The first frame is fetched from the memory 58, further processed, and transmitted to the display device 24 where it is rendered.

After an interframe period, a second image is captured by the image sensor 46 and a second frame of image data is transmitted to the display controller 26. The pixels of the first and second frames are, in a preferred embodiment, transmitted in the same order. For example, the first and second frames are transmitted in raster order.

Each pixel of the second frame is presented to the intelligent multiple exposure unit 78. The intelligent multiple exposure unit 78 compares at least one parameter value for pixels of the second frame with a first threshold to determine if a first condition is true. In another embodiment, each pixel of the subsequent frame may be additionally compared with a second threshold to determine if a second condition is true. In still other embodiments, each pixel of the subsequent frame may be additionally compared with a plurality of thresholds to determine if a corresponding number of conditions are true. The first, second, and other thresholds, and the first second, and other conditions, are examples of the process parameters referred to above. The intelligent multiple exposure unit 78 obtains the first threshold, the first condition, and any other thresholds and conditions from the register 80.

As mentioned above, a pixel may be defined by a single gray scale parameter, or three parameters such as R, G, and B, or Y, U, and V. In various embodiments, it is these types of parameters for pixels of the second frame that the intelligent multiple exposure unit 78 compares with one or more thresholds. The first and other thresholds are specified in the same scale as the particular parameter.

As one example, the pixel parameter value may be an 8-bit gray scale value, i.e., a value between 0 and 255, inclusive, and the first threshold may be a gray scale value of 200. The intelligent multiple exposure unit 78 compares the parameter value for pixels of the second frame with a first threshold to determine if a first condition is true. The first condition, in this example, is that the parameter value is greater than the first threshold. In another embodiment, the first condition is that the parameter value is less than the first threshold.

The intelligent multiple exposure unit 78 selects pixels of the second frame for which the first condition is true. The intelligent multiple exposure unit 78 causes the parameter values for each selected pixel of the second frame to be stored in the memory 58. Continuing the example of the preceding paragraph, if a particular pixel has a gray scale value of 201-255, say 214, the first condition is true. Therefore, the pixel is selected and stored in the memory 58.

In one embodiment, the intelligent multiple exposure unit 78 compares at least two parameter values for pixels of the second frame respectively with first and second thresholds to determine if first and second conditions are true. In this alternative, the pixel may be selected if the first condition is true, the second condition is true, or both the first and second conditions are true. For example, the first parameter value may be R and the second G, the first threshold 50 and the second 75, and the first condition is that the parameter value is greater than the first threshold and the second condition is that the parameter value is greater than the second threshold. Further, a pixel is selected only if both conditions are true. Under these criteria, a pixel of the second frame is selected if its R value is greater than 50 and its G value is greater than 75.

In other embodiments, as many conditions and thresholds may be employed as desired.

The selected pixels of the second frame are stored subsequent to the storing of pixels of the first frame. In addition, the selected pixels of the second frame are stored in a destructive write operation. In a destructive write operation, the parameter values of a particular selected pixel of the second frame replace the parameter values of a pixel of the first frame having coordinates that are the same as the particular selected pixel. Continuing the example above of the gray scale pixel having a value of 214, if the gray scale value of the corresponding pixel of the first frame is 40, this value of 40 will be overwritten with the value of the selected pixel of the second frame, i.e., with 214.

The intelligent multiple exposure unit 78 may be comprised of a plurality of discrete logic gates and devices selected and designed to perform the functions described as well as other functions. Alternatively, the intelligent multiple exposure unit 78 may be comprised of gates and devices produced by a hardware definition language, such as Verilog™ or VHDL. In addition, the register 80 may comprise one or more than one storage devices. The register may a discrete device such as a flip-flop or a plurality of flip-flops integrated on the IC of the display controller, or it may comprise one or more storage locations in a memory, such as the memory 58.

While the intelligent multiple exposure unit 78 may be coupled with the image processing unit 62a, as shown, this is not critical. In other embodiments, the intelligent multiple exposure unit 78 may be coupled directly with the image sensor interface 46, or may be coupled directly with any source of image data.

The description of the intelligent multiple exposure unit 78 above assumes that the unit operates on image data generated by the image sensor 22. In other embodiments, the intelligent multiple exposure unit 78 may operate on image data generated or provided by any source of image data. For example, the intelligent multiple exposure unit 78 may operate on image data provided by the host 28 via the host interface 48 and bus 75.

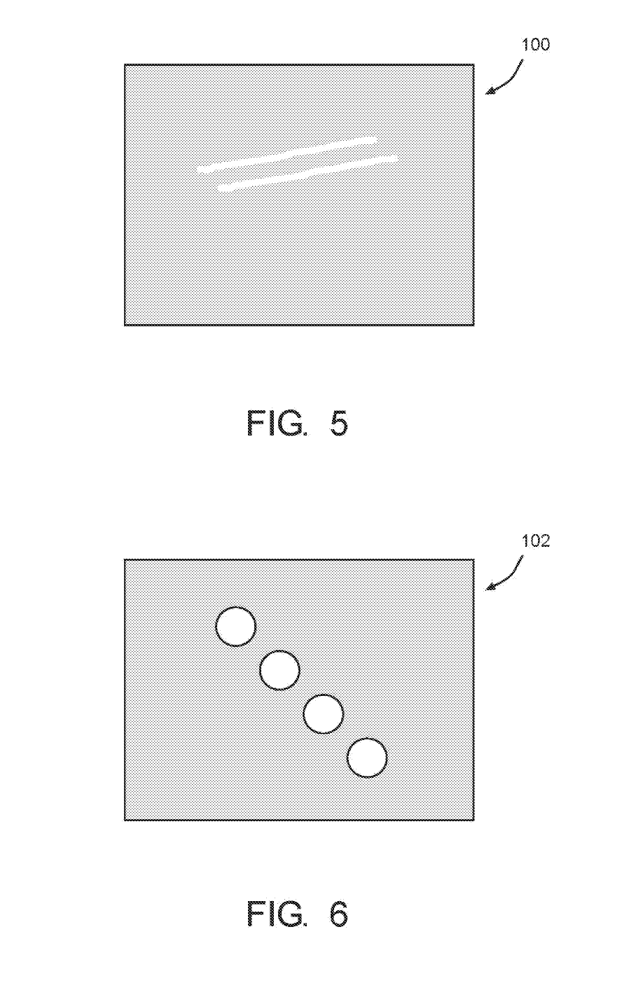

Prophetical images that may be created using embodiments of the claimed inventions are illustrated in FIGS. 5, 6, and 7.

FIG. 5 illustrates a first image 100 created from multiple frames of image data. The subject of the images is a pair of automobile headlights. The frames are captured under conditions of low ambient light, such as outdoors between twilight and dusk. Hence, the background is dark. The multiple exposure image is created from a very large number of sequentially captured images. Each exposure is separated by relatively short interframe periods. FIG. 5 is intended to depict the pair of headlights as streaks of light that follow the path of an automobile.

FIG. 6 illustrates a second image 102 created from multiple frames of image data. FIG. 6 depicts a light-reflecting ball falling in front of a light-absorbing background, such as black screen. Each exposure is illuminated causing the ball to appear significantly brighter than the background screen. Further, each of the four frames from which the image is formed is separated by relatively long interframe periods.

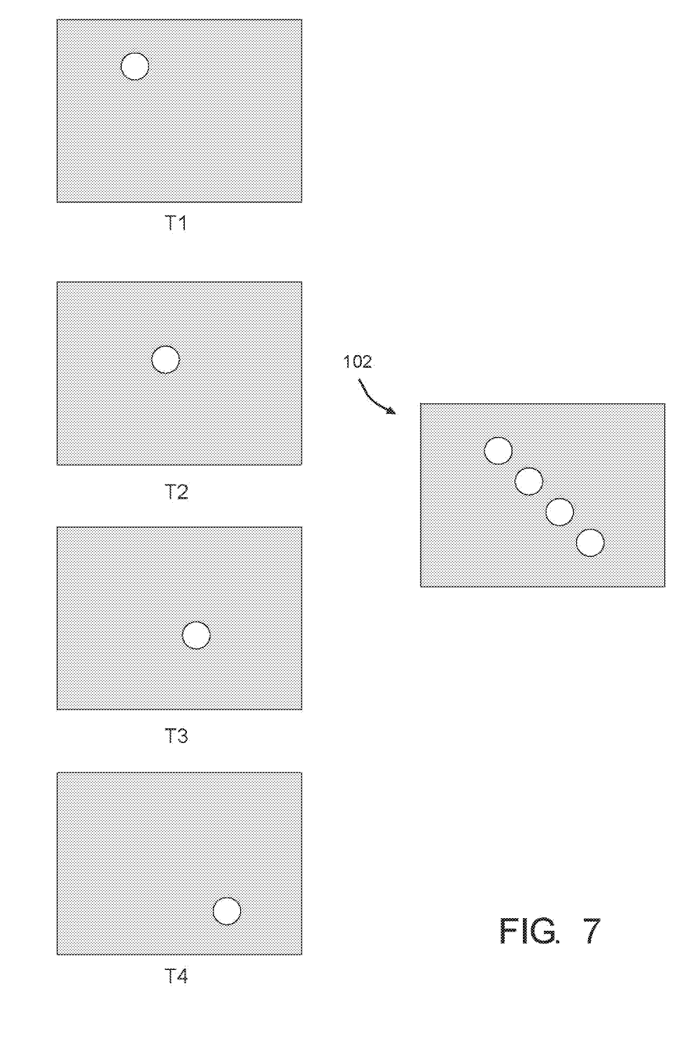

FIG. 7 illustrates the second image 102 of FIG. 6, and the multiple frames from which the multiple exposure image 102 was created. The multiple frames are captured at sequential times T1, T2, T3, and T4. Each such time is separated by an interframe period. Multiple exposure image 102 is formed by first storing the frame captured at time T1. Subsequently, each of the pixels of the frame captured at time T2 are compared with a first threshold. The frames are gray-scale images and the first threshold is specified so that the pixels of the light-reflecting ball exceed the first threshold, but the pixels of the background are less than the first threshold. The first condition is that the at least one parameter is greater the first threshold. Accordingly, pixels of the frame captured at time T2 are selected for storing only if the exceed the first threshold, that is, only the pixels of the light-reflecting ball are selected. Similarly, in the frames captured at times T3 and T4, only the pixels of the light-reflecting ball are selected for storing.

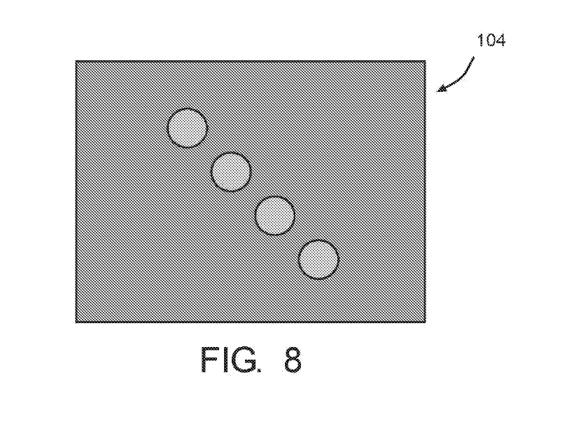

For comparison purposes, another prophetical image is shown in FIG. 8. In contrast, the multiple exposure image 104 of FIG. 8 is created by sequentially storing the frames captured at time T1, T2, T3, and T4 in an additive write operation. As can be seen, the background is darker than with multiple exposure image 102, illustrating the overexposure problem described above. In addition, another problem with image 104 is that the light-reflecting balls are darkened as a result of being added with the background image.

The register 80 stores various process parameters. As mentioned, the intelligent multiple exposure unit 78 compares at least one parameter value for pixels of the second frame with a first threshold to determine if a first condition is true. In one or more embodiments, process parameters are used to specify the first threshold. Further, in one or more embodiments, process parameters are used to specify one or more types of parameter values for defining pixels. For example, process parameters may be used to specify that a gray scale, red, green, blue, luma, or color difference value is to be compared with the first threshold.

Process parameters may be used to specify two or more thresholds. In addition, process parameters may be used to specify two or more types of parameter values for defining pixels, e.g., red and green. The intelligent multiple exposure unit 78 compares the red parameter values of RGB pixels with the first threshold and the green values with the second threshold. The unit 78 determines if a first condition is true with respect to the first threshold and if a second condition is true with respect to the second threshold. In one embodiment, the unit 78 selects pixels of the second frame for which both the first and second conditions are true. In another embodiment, the unit 78 selects pixels of the second frame for which either the first and or second conditions are true.

In one or more embodiments, the process parameters may be used to specify the exposure of each of the frames. For example, using the process parameters, the exposure of the second frame can be set to be equal to the exposure of the first frame. Alternately, the exposure of the second frame can be set to be different from the exposure of the first frame.

In one or more embodiments, the process parameters may be used to specify the interframe period. In one embodiment, the exposure of the second frame begins substantially immediately following the exposure of the first frame. In another embodiment, the exposure of the second frame begins following a particular time period following the exposure of the first frame. In other embodiments where three or more frames are used to create a multiple exposure image, a unique interframe period may be specified for each pair of successive frames.

In addition, the process parameters may be used to specify the number of frames to be used in creating a multiple exposure image. Various embodiments may be configured so that any number of frames may be specified. For example, in one embodiment, a multiple exposure image can be created with up to 64 frames. In other embodiments, a multiple exposure image can be created with up to 256, 512, or 1,024 frames.

The exemplary device 20 and other embodiments that incorporate one or more of the claimed inventions provide advantages over known devices. Specifically, they permit the creation of a multiple exposure image in which the background image is not exposed to too much light. In addition, they permit the creation of a multiple exposure image that can be viewed virtually instantly following the capture of the final frame. Moreover, they permit the creation of a multiple exposure image in a manner which uses a minimal amount of memory. There is no need to store each of the multiple frames from which the image is formed in memory. This reduces power requirements, which is especially important in mobile devices.

Moreover, the exemplary device 20 and other embodiments that incorporate one or more of the claimed inventions permit the creation of a multiple exposure image in which the first image is taken of a desired background scene and the second image is taken of an object to be “pasted” into the scene. This effect is accomplished by taking the second image of the object in front of a black background scene. To illustrate, let the first image be taken of a scene of the Leaning Tower of Pisa. Let the second image be taken of an individual standing in front of a black screen. In addition, if the image is a gray scale image, let the first threshold be set at a value of above the black screen. For example, if the value of the black screen is 25, the first threshold may be set at 50. Let the first condition be “greater than.” The intelligent multiple exposure unit 78 will then select pixels of the second frame for which the pixel value is greater than 50, storing the image of the individual over the background scene. It will be appreciated that this effect of “pasting” an object over a background scene may be accomplished with a variety of alternative background colors. For example, blue, red, or green.

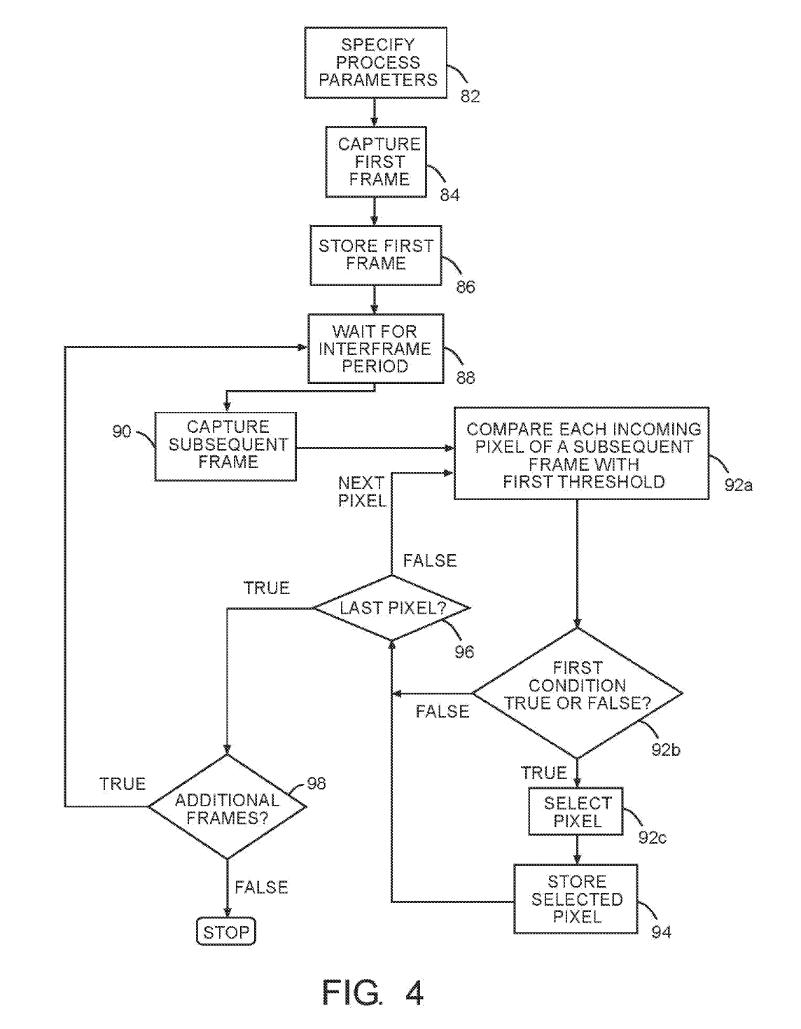

FIG. 4 is a flow diagram of an exemplary method. The method can begin with specifying one or more process parameters (step 82). Alternately, the process parameters may be predetermined. A first frame is captured (step 84) and the pixels of the first frame are stored in a memory (step 86). Specifically, the parameter values that define the pixels are stored in a memory.

Following the capture of the first frame, an interframe period is allowed to elapse (step 88). The interframe period may be specified by a process parameter or it may be a default period. Subsequently, a subsequent frame is captured (step 90). The pixels of the first and second frames are, in a preferred embodiment, arranged in the same order.

Each pixel of the subsequent frame is compared with a first threshold to determine if a first condition is true (step 92a). This comparison compares at least one of the parameter values used to define the pixels of the subsequent frame with the first threshold. The first condition, in one embodiment, is that the parameter value is greater than the first threshold. In another embodiment, the first condition is that the parameter value is less than the first threshold. A determination is made if the first condition is true or false (step 92b). The pixel is selected if the first condition is true (step 92c).

While not shown in FIG. 4, each pixel of the subsequent frame may be additionally compared with a second threshold to determine if a second condition is true. The second condition may be that the parameter value is greater or less than the second threshold. In addition, a determination is made if the second condition is true or false. In this alternative, the pixel may be selected if either the first condition or the second condition is true, or if both the first and second conditions are true.

In another embodiment, each pixel of the subsequent frame may be additionally compared with a second threshold to determine if a second condition is true, and compared with a third threshold to determine if a third condition is true. After a determination is made if the second and third conditions are true or false, a pixel is selected. In this alternative, the pixel may be selected if all of the first, second, and third conditions are true, or if one or more of the three conditions are true. As many conditions as desired may be employed. Further, as many of the parameters used to define the pixels as desired may be compared with a particular threshold. As an example, the first condition may be that a pixel's luma value be greater than 180, the second condition may be that the pixel's U value be less than 40, the third condition may be that the pixel's V value be greater than 197, and the fourth condition may be that the pixel's V value be less than 233. In this example, only pixels for which all four conditions are true are selected. This example provides for the selection of pixels having at least a particular luma value, as well as falling within a specific range of colors.

The selected pixel of the second frame is stored in the memory (step 94). The selected pixel of the second frame is stored in a destructive write operation. In this operation, a pixel of the first frame which has the same coordinates as the selected pixel of the second frame is overwritten.

Subsequent to step 92b if the first condition is false, or subsequent to step 94 if the first condition is true, a determination is made if the pixel just compared with the first threshold is the last pixel in the frame (step 96). If this pixel is not the last pixel, the method returns to step 92a where the next pixel in the frame is compared with the first threshold. Otherwise, the method proceeds to step 98.

A determination is made if the pixels of an additional frame are to be compared with the first threshold (step 98). The number of subsequent frames to be used in creating a multiple exposure image may be specified by a process parameter or there may be a default number of frames. If the desired number of frames has been processed, the method concludes and the frame stored in the memory may be rendered for display, stored, or transmitted as the desired multiple exposures image. Alternatively, the method returns to step 88 to wait an interframe period and then proceeds to step 90 where another subsequent frame is captured.

The claimed inventions have been described in the context of image data received from an image sensor that is integrated in the system or device. It should be appreciated that the claimed inventions may be practiced with image data that is received from any image data source, whether integrated or remote. For example, the image data may be transmitted over a network by a device remote from the system or device incorporating one or more of the claimed inventions.

Any of the operations described herein that form part of the claimed inventions are useful machine operations. The claimed inventions also relate to a devices or apparatus for performing these operations. The devices may be specially constructed for the required purposes, such as the described mobile device, or they may be a general purpose computer selectively activated or configured by a computer program stored in the computer. In particular, various general purpose machines may be used with computer programs written in accordance with the claimed inventions, or it may be more convenient to construct a more specialized apparatus to perform the required operations.

The claimed inventions may be embodied as computer readable code on a computer readable medium. The computer readable medium is any data storage device that can store data which can be thereafter read by a computer system. Examples of the computer readable medium include flash memory, hard drives, network attached storage, ROM, RAM, CDs, magnetic tapes, and other optical and non-optical data storage devices. The computer readable medium can also be distributed over a network-coupled computer system so that the computer readable code is stored and executed in a distributed fashion.

The claimed inventions may be practiced with a wide variety of computer system configurations including hand-held devices, microprocessor systems, microprocessor-based or programmable consumer electronics, minicomputers, mainframe computers and the like. Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

1. A method for creating a multiple exposure image from two or more frames of pixels, each pixel defined by at least one parameter, the method comprising:
storing pixels of a first frame in a memory;
comparing, for pixels of a second frame, at least one parameter for defining pixels with a first threshold to determine if a first condition is true;
selecting pixels of the second frame for which the first condition is true; and
storing selected pixels of the second frame in the memory subsequent to the storing of the pixels of the first frame by replacing corresponding pixels of the first frame with the selected pixels.

2. The method of claim 1, wherein the first condition is one of the at least one parameter being greater than or less than the first threshold.

3. The method of claim 2, wherein the first threshold specifies one of a brightness or a color difference parameter.

4. The method of claim 2, wherein the first threshold specifies a color parameter.

5. The method of claim 1, wherein the first frame is created with a first exposure and the second frame is created with a second exposure, and the first exposure and the second exposure are each adjustable.

6. The method of claim 1, wherein the first frame is created with a first exposure and the second frame is created with a second exposure, and an interframe period between the first exposure and the second exposure is adjustable.

7. The method of claim 1, further comprising:
comparing, for pixels of a third frame, at least one parameter for defining pixels with the first threshold to determine if the first condition is true;
selecting pixels of the third frame for which the first condition is true; and
storing selected pixels of the third frame in the memory subsequent to the storing the selected pixels of the second frame by replacing corresponding pixels of the first frame with the selected pixels of the third frame.

8. An apparatus for creating a multiple exposure image from two or more frames of pixels, each pixel being defined by one or more parameters, the apparatus comprising:
a first memory to store pixels of a first frame; and
a comparing unit to compare at least one parameter with a first threshold to determine if a first condition is true, to select pixels for which the first condition is true, and to store the selected pixels in the first memory subsequent to the storing the first frame by replacing corresponding pixels of the first frame with the selected pixels, wherein the comparing unit compares pixels of a second frame.

9. The apparatus of claim 8, wherein the first condition is one of the at least one parameter being greater than or less than the first threshold.

10. The apparatus of claim 8, wherein the first threshold specifies one of a brightness or a color difference parameter.

11. The apparatus of claim 8, further comprising a second memory coupled with the comparing unit to store parameters used by the comparing unit.

12. The apparatus of claim 8, wherein the comparing unit compares pixels of a third frame and stores the selected pixels of the third frame in the memory subsequent to the storing of the selected pixels of the second frame.

13. The apparatus of claim 8, wherein the comparing unit compares at least one parameter with a second threshold to determine if a second condition is true, and selects pixels for which both the first and second condition are true.

14. The apparatus of claim 8, wherein the comparing unit compares at least one parameter with a second threshold to determine if a second condition is true, and selects pixels for which one of the first and second conditions is true.

15. A system for creating a multiple exposure image from two or more frames of pixels, each pixel being defined by one or more parameters, the system comprising:
a first memory to store pixels of a first frame; and
a comparing unit to compare at least one parameter with a first threshold to determine if a first condition is true, to select pixels for which the first condition is true, and to store the selected pixels in the first memory subsequent to the storing the first frame by replacing corresponding pixels of the first frame with the selected pixels, wherein the comparing unit compares pixels of a second frame, and wherein the first condition is one of the at least one parameter being greater than or less than the first threshold.

16. The system of claim 15, wherein the first memory is of a size sufficient to store not more than one frame.

17. The system of claim 15, further comprising an image sensor.

18. The system of claim 16, further comprising a display device.

19. The system of claim 17, further comprising a host.

20. The system of claim 15, wherein the first threshold specifies a gray scale parameter.

21. An IC for creating a multiple exposure image from two or more frames of pixels, each pixel defined by at least one parameter, the IC comprising:
a multiple exposure unit that:
compares pixels of a second frame to at least one parameter to define pixels with a first threshold to determine if a first condition is true;
selects pixels of the second frame for which the first condition is true; and
replaces corresponding pixels of the first frame with the selected pixels.

22. The IC of claim 21, wherein the first threshold specifies a gray scale parameter.

23. The IC of claim 21, wherein the first condition is one of the at least one parameter being greater than or less than the first threshold.

24. The IC of claim 23, wherein the first threshold specifies one of a brightness or a color difference parameter.

25. The IC of claim 23, wherein the first threshold specifies a color parameter.
